(19) United States
(12) Patent Application Publication
(10) Pub. No.: US 2010/0279769 A1
(43) Pub. Date: Nov. 4, 2010

(54) Game controller with display screen

(76) Inventor: Chira Kidakam, Lawndale, CA (US)

Correspondence Address: DAVID AND RAYMOND PATENT FIRM, 108 N. YNEZ AVE., SUITE 128, MONTEREY PARK, CA, 91754, US

(21) Appl. No.: 12/798,965

(22) Filed: Apr. 13, 2010

Related U.S. Application Data
(60) Provisional application No. 61/212,662, filed on Apr. 13, 2009.

(51) Int. Cl. A63F 13/00; A63F 13/06

(52) U.S. Cl. 463/31; 463/36

(57) ABSTRACT

A game controller is adapted for operatively connecting with a game console to controllably play the video game displayed on an external display, wherein the game controller includes a controller body for a gamer to hold and selectively control the input of the game console, and a display screen provided on the controller body for displaying information on the display screen related to the video game so as to enable the gamer to conveniently read the information and play the video game at the same time.

### BACKGROUND OF THE PRESENT INVENTION

1. Field of Invention

The present invention relates to a controller, and more particularly to a game controller for controlling an external game console which is electrically connected to an external display, wherein the game controller comprises a display screen provided onto the game controller for displaying information corresponding to the game displaying on the external display.

2. Description of Related Arts

Game consoles are one of the main entertainment devices in the daily life. The home game entertainment generally comprises an external game console connecting to an external display screen, such as TV, and a game controller wirelessly or by wired connecting to the game console to control and communicate with the game console. Therefore, the player is able to play the game displayed on the external display and to control the game via the game controller.

Modern video games, especially for the home entertaining game console, such as “street fighters”, have a dramatic need of a guiding book, such as a manual booklet for indicating the tips of the video game due to the complication of the video game. In order to overcome the difficulties of the video game, the player normally has to look up the manual booklet of guiding book to find out the key points of the video game. Those booklets instruct the players on how to play the game. The manual booklet can be large, such as three hundred pages manual book, or small, such as one single sheet of double-sided paper to simply give the player the concept and key points of the game.

Some of the disadvantages are occurred for those instruction manuals of video games. One of the main concerns is easily missing the manual booklets. The funs of video games tend to have lots of manual booklets for each of the video games. The players may mess up which manual booklets of which video games. Unless the player is really good at organizing and keeping everything back to its original place, those large manual books or small single sheet instructions are easily missing or disappearing inadvertently.

Lots of video game players re-sell the video games that they conquered to a used video game market. Games acquired in second hand markets often miss the manuals, after being kept, lost or discarded by their previous owners. As occasionally the manuals are part of the game experience, owners of games missing manuals try to find replacements in other second-hand stores or with other players or collectors.

While playing the video games, the players may want to check out the instructions of how to play the video game. The player has to temporally pause the video game and find the manual of the video game. They may have to look up the thick and large manual book just for finding out the part of tips that they need. It is time consuming and exhausting.

Storage for those manuals of video games is another drawback. Especially for those thick and large manual books of video games, they have to occupy a significant space for storing the manuals.

The growing complication and sophistication of video games increasingly require several sub-windows to show the information of the video game at the same time, such as maps and equipments of the video game. Some of the video games having 360° viewing angle even show different sceneries of the different angles in a separated sub-window.

The sub-window provides important information for the players to find out the information of the video game and can enjoy the video game in many ways. Through the sub-windows, the video game enables the player to see the different environment from different angles at the same time. However, those sub-windows also significantly reduce the main viewing area of the video game displayed on the external display screen. It may cover the important scenery and decrease the realistic feeling of the video game.

### SUMMARY OF THE PRESENT INVENTION

A main object of the present invention is to provide a game controller with a display screen to solve the above drawbacks of the video game related issues.

Another object of the present invention is to provide a game controller with a display screen, wherein the display screen is able to display the instructions or manual of the video game.

Another object of the present invention is to provide a game controller with a display screen, wherein the display screen is a holder for holding the instructions of the video game for displaying while the player is playing the video game.

Another object of the present invention is to provide a game controller with a display screen, wherein the display screen is a LCD screen for electrically displaying the manual or instructions of the video game.

Another object of the present invention is to provide a game controller with a display screen, wherein the display screen is capable of interacting with the video game.

Another object of the present invention is to provide a game controller with a display screen, wherein

Accordingly, in order to accomplish the above objects, the game controller with display screen comprises a game controller for wirely or wirelessly connected to an external game console, wherein the game console is electrically connected to an external display for displaying information of a video game of the game console, so as to communicate with a gamer of the video game.

These and other objectives, features, and advantages of the present invention will become apparent from the following detailed description, the accompanying drawings, and the appended claims.

### BRIEF DESCRIPTION OF THE DRAWINGS

FIG. 1 is block diagram of a game controller with display screen according to a preferred embodiment of the present invention, illustrating the game controller incorporating with an external game console and external display electrically connected to the game console.

FIG. 2 is a perspective view of a game controller with display screen according to the above preferred embodiment of the present invention.

FIG. 3 is a perspective view of the game controller with display screen according to the above preferred embodiment of the present invention, illustrating another location of the display screen.

### DETAILED DESCRIPTION OF THE PREFERRED EMBODIMENT

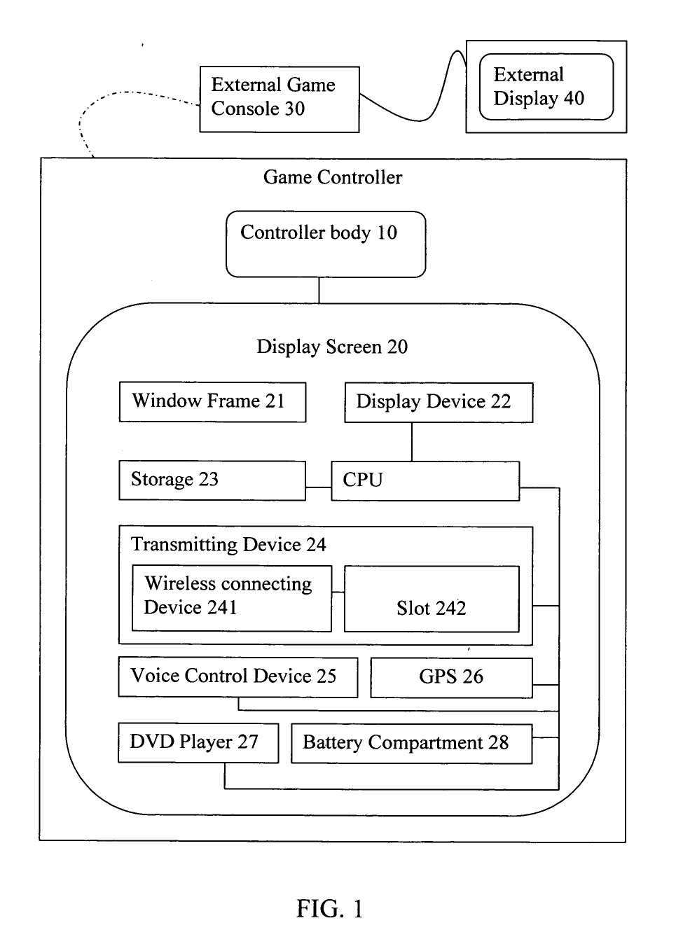

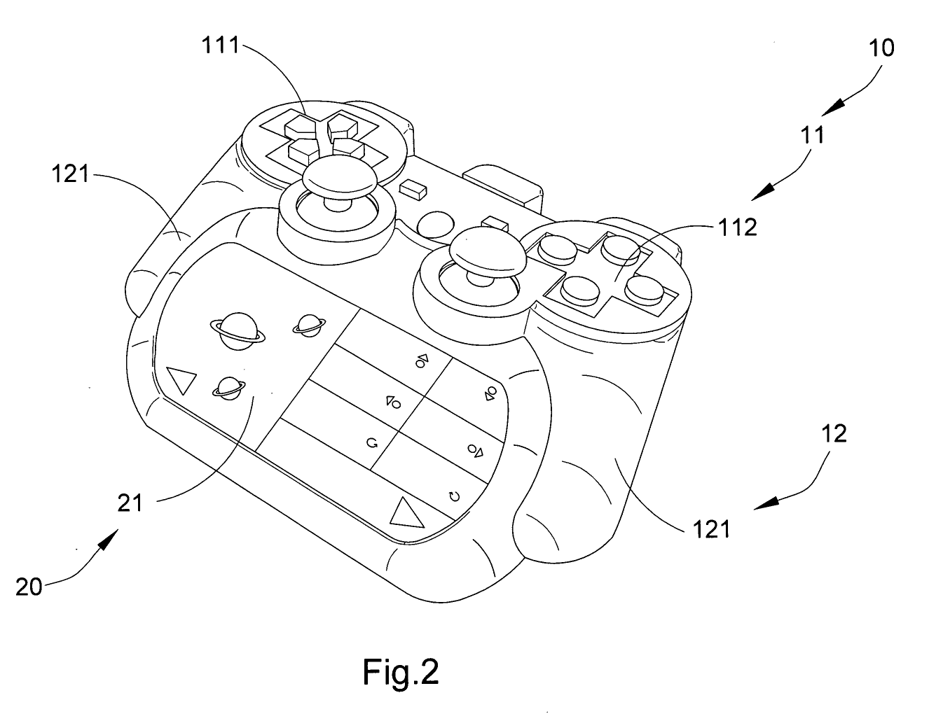

Referring to FIGS. 1 and 2 of the drawings, a game controller with a display screen according to a preferred embodiment of the present invention is illustrated, wherein the game controller comprises a controller body 10 for a gamer to hold and selectively control the input of an external game console 30, and a display screen 20 provided at the controller body 10 of the game controller for displaying information on the display screen 20 related to the video game so as to enable the gamer to conveniently read the information and play the video game at the same time.

The game controller is adapted for electrically connected to the external game console 30, especially for home entertaining game console, such as “Play station”, “Xbox 360”, wherein the game controller is wirely or wirelessly connected to the external game console 30 for controllably communicating with the game console via an external display 40 electrically connected to the game console 30 for displaying information of a video game.

The controller body 10 of the game controller further has a controlling portion 11 for controllably communicating with the game console 30, and a holding portion 12 provided for a gamer of the video game comfortably holding the game controller to control the game console via the controlling portion 11, wherein the controlling portion 11 and the holding portion 12 are integrally formed one piece of the game controller. The holding portion 12 has two handle parts 121 provided for being held by two hands of the gamer, so that the game controller is able to be held with two hands of the gamer in a typical operating manner.

The controller body 10 further has a first controlling set 111 at one side of the controlling portion 11 and a second controlling set 112 at another side of the controlling portion, wherein a plurality of functional buttons are operatively located at the first and second controlling sets 111, 112.

In order to incorporate the display screen 20 with the controller body 10 of the game controller, the display screen 20 is provided between the two handle parts 121 of the holding portion 12 of game controller, so that the gamer is able to conveniently read the display screen 20 in front of the gamer while the gamer is holding the game controller, as shown in FIG. 2.

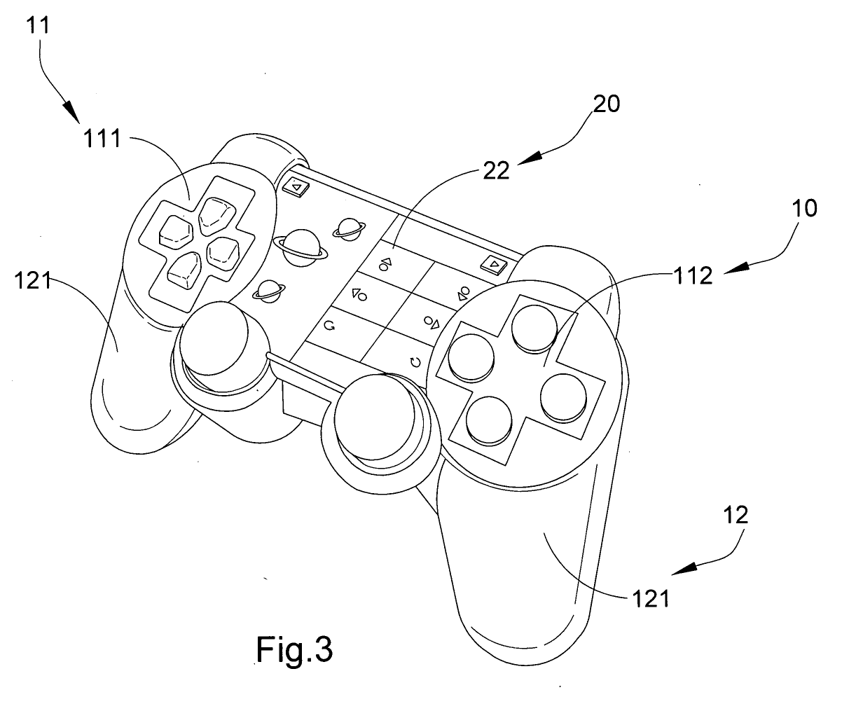

Alternatively, the display screen 20 can be provided on the controller body 10 at the position between the first and second controlling sets 111, 112 to integrally mount with the controller body 10 of the game controller, so as to integral with the controller body 10 to form one piece game controller, as shown in FIG. 3. The display screen 20 can also be electrically connected to the controller body 10 to display electronic information which is related to the video game of the external game console 30. Accordingly, the display screen 20 incorporated with the controller body 10 is capable of interacting with the video game.

More specifically, the display screen 20 is detachably coupling with the game controller at an outer peripheral edge between the two handle parts 121 of the holding portion 12 and the controlling portion 11 of the controller body 10, such that the display screen 20 is facing towards the gamer for displaying purpose. Thus, the detachable display screen 20 is coupling with the controller body 10 via a screw or an interlocking manner to incorporate the display screen 20 with the controller body 10, so that the gamer is able to detach the display screen 20 of the game controller when the gamer has no need of the display screen 20.

As shown in FIG. 2, the display screen 20 is embodied as a window frame 21 having a display window for displaying a related information of the video game, such as a picture or manual, which may be a double-sided signal sheet having instructions of the video game, such that the user is able to conveniently read the instructions of the video game manual while the gamer is playing the video game. In other words, the instruction sheet can be slid into the window frame 21 within the display window for the user to read the instruction at the controller body 10 and to play the video game at the external display 40 at the same time.

Alternatively, the display screen 20 comprises a display device 22 built-in with the controller body 10 for electrically displaying the video game related information, as shown in FIG. 3, wherein the display device 22 is preferably embodied as a LCD screen 221 electrically connected to the controller body 10 of the game controller via a CPU of the display device 20. Accordingly, the CPU of the display device 20 can be the same as the CPU of the controller body 10 as a common central processor when the display device 20 is built-in with the controller body 10 such that the CPU can control the controller body 10 and the display device 20 at the same time.

It is appreciated that the locations of the display screen 20 in FIGS. 2 and 3 are interchangeable that the LCD screen 221 of the display device 22 can be located between the two handle parts 121 of the holding portion of the controller body 10 while the window frame 21 can be located on the controller body 10 at the position between the first and second controlling sets 111, 112.

The video related information, such as a manual, is able to be downloaded through the external game console 30 having the video game related information. For instance, a video game DVD having the related video game manual saved in the DVD is being operated via the game console 30, wherein the game controller is wirelessly or by wire connected to the external game console 30, so as to download the electronic manual of the video game for being displayed in the LCD screen 221 of the display screen 20.

Accordingly, the display screen 20 is also capable of interacting with the video game of the game console, wherein the display screen 20 is able to be used as a sub-screen adapted for displaying at least one sub-window of the video game. For example, lots of real-time strategy video games usually have at least one sub-window for showing multiple information of the video game at the same time, such as a map of the video game, so that the gamer is able to recognize the location where he or she is. Some of the video games have plenty of equipments adapted for the gamer selectively using in different environment of the video game. In order to efficiently display the equipment for the gamer, the sub-window is able to be popped out during playing the video game.

Thus, the display screen 20 is capable of being used as the sub-window for displaying those common sub-windows designed to corporate with the video games. It is worth mentioning that the sub-windows of the video games are normally showed on the external display 40 and occupied a significant displaying area of the external display 40. The display screen 20 detachably coupling at the controller body 10 is able to utilize the displaying area of the external display 40 by showing the sub-windows on the display device 22 of the display screen 20 of the game controller.

Another example for using the display screen 20 as a sub-screen of the video game is a car or motorcycle racing game, wherein the racing game has at least one sub-window as a side mirror of the car or motorcycle for showing the rear, right, or left side view. Therefore, the display screen 20 is capable of interacting with the video game and display the view from the side mirror on the LCD screen 221 of the display device 22 of the display screen 20.

For those video games which can show a wide view, such as a 3-D shooting game having a 360° viewing angle, may also need the sub-windows for conveniently showing the environment or background from different angle of view at the same time. Thus, the display screen 20 is able to show the different angle of view of the video game for maximize the viewing area of the external display 40.

The electronic manual of the video game can be interactively displayed on the LCD screen 221 of the display device 22 of the display screen 20, wherein a specific part of the electronic manual is able to be automatically shown on the display screen 20 regarding to a process of the video game. In order words, the gamer has no need to hardly try finding out the specific part of the manual regarding to the specific process of the video game that the gamer is playing, so that the manual is able to simply and automatically show on the display screen 20 as the gamer wanted.

The display screen 20 is able to input information for communicating with the game console or control the display screen 20 via the controlling portion 11 of the controller body 10 of the game controller. In order to conveniently input information and communicating with the external game console 30 or other devices directly through the display screen 20, the LCD screen 221 is further embodied as a touch screen, so that the gamer is able to directly communicate with the external game console 30 or the LCD screen 221 via the touch screen.

A plurality of controlling buttons may be provided at the display screen 20 and electrically connected to the display screen 20 in a controlling manner, so that the gamer also can communicate with the display screen 20 through the controlling buttons. The game controller further comprises a voice control device 25 provided in the display screen 20 for controllably controlling the video game or the other devices via the voice control device 25 of the display screen by the voice of the gamer.

In order to wildly facilitate the game controller, the display screen 20 further comprises a storage 23 for temporarily or permanently storing a necessary or related information of the video game. A transmitting device 24 of the display screen 20 may be further adapted for independently to operate the game controller to download the necessary or related information of the video game and store at the storage 23 of the display screen 20 of the game controller. The transmitting device 24 comprises a wireless connecting device 241 for wirelessly downloading or uploading information, such as downloading or uploading from an internet through a personal computer, and a wire connecting device 242 having at least one slot for communicating display screen 20 of the game controller with an external device, such as a computer.

Accordingly, the game controller is able to input and/or output information either through the controller body 10 of the game controller itself, or the transmitting device 24 of the display screen 20 of the game controller. Thus, the game controller is capable of downloading an unlock code of the video game either through the external game console 30 or from the internet via the personal computer, such as the unlock code for unlocking the limited characters of the video game or levels of the video game.

For example, if the gamer did not pass the first level of the video game, he or she may need the unlock code to play the next level of the video game. Downloading the unlock code directly through the game controller via the display screen 20 not only enhance the convenience for the gamer, but also enable the gamer editing directly via the touch screen of the display screen 20.

The game controller can also be used as an electronic photo frame for electronically displaying a plurality of photos saved in the storage 23 of the display screen 20 on the LCD screen 221 of the display device 22. The display screen 20 incorporated with the controller body 10 of the game controller is capable of wirelessly or by wire connecting to an external device, such as personal computer or mp3, to download the photos stored therein, so that the photos are able to be automatically and selectively showed on the LCD screen 221 by being processed via a processing unit in the display screen 20 of the game controller.

Furthermore, the game controller with the display screen 20 can be installed some of the simple games for being processed by the processing unit, so that the game controller is able to be played alone by the game controller itself when the game controller is not in use for the external game console 30.

A time management program can be further installed into the display screen 20 of the game controller, so that the time management is able to record how long that the gamer has been playing. The time management program is also capable of restricting playing time by set up a predetermined time for playing, such that the gamer will be warned or stopped keep playing the video game, so as to enforce or warning the gamer to rest himself or herself

Another chat program may be applied to the game controller via the video game or external game console 30, so that the gamer is able to communicate with another gamer via the game controller, or more particularly via the touch screen of the LCD 221 of the display device, in such manner that the gamer is able to easily communicate with the other gamer, such as typing via a key board displayed on the touch screen of LCD screen 221 or selecting a pre-set up conversation of the video game or the display screen 20.

Some other utility features may further applied on the display screen 20 of the game controller, so that the game controller is capable of being used alone and/or being portably carried for different purposes, so as to fully utilize the function of the game controller or allow the gamer using his or her own game controller everywhere.

Therefore, the application programs, such as above mentioned simple games, time management program, and the chat program installed at the storage 23 of the display device 22 of the display screen 20 is able to utilize the game controller by installing the application programs as add-on functions.

The utility features include GPS, or DVD player when the game controller is not in use, wherein the game controller may further comprises GPS system 26 provided in the display screen 20, so that the GPS system 26 allows the game controller for being used as a GPS. When the gamer is driving or looking for a specific location or place, the game controller is capable of being used as the GPS for guiding purpose.

The display screen 20 of the game controller can provide a DVD player for playing the DVD simply via the display screen 20 of the game controller, such that the game controller can also provide the portable DVD player function for playing the DVD via the display screen 20. Since the gamer would like to carry his/her own game controller for game tournament or playing game with other gamers, the gamer can use the game controller of the present invention as the GPS or DVD player during touring.

Accordingly, in order to provide the above portable functions of the game controller, a battery compartment 28 is further provided in the display screen 20 and/or the controller body 10 of the game console for receiving at least one battery therewithin, such that the battery is electrically providing the necessary electrical energy to the game controller via the battery compartment 28.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A game controller for controlling an external game console, comprising:
a controller body having a holding portion for being held by a gamer and a controlling portion for controllably communicating with said external game console; and
a display screen located adjacent to said holding portion for displaying information related to a video game of said game console on said display screen so as to enable said gamer to conveniently read the related information while playing said video game through said game controller.

2. The game controller, as recited in claim 1, wherein said display screen is a display device electrically connected to a CPU of said controller body for electrically displaying said related information of said video game of external game console.

3. The game controller, as recited in claim 2, wherein said display screen further comprises a storage electrically linked to said CPU of said controller body for temporarily or permanently storing digital information, and a transmitting device electrically linked to said CPU for independently operating said game controller to download related or non-related information of said video game and store at said storage thereof.

4. The game controller, as recited in claim 2, wherein said display screen is a sub screen for displaying a sub-window information of said related video game for incorporating an external display screen of said external game console.

5. The game controller, as recited in claim 3, wherein said display screen is a sub screen for displaying a sub-window information of said related video game for incorporating an external display screen of said external game console.

6. The game controller, as recited in claim 2, wherein one or more application programs are installed in said storage of said display screen to form multi-functional game controller.

7. The game controller, as recited in claim 3, wherein one or more application programs are installed in said storage of said display screen to form multi-functional game controller.

8. The game controller, as recited in claim 5, wherein one or more application programs are installed in said storage of said display screen to form multi-functional game controller.

9. The game controller, as recited in claim 2, wherein said display screen is a LCD touch screen for directly communicating with said external game console.

10. The game controller, as recited in claim 5, wherein said display screen is a LCD touch screen for directly communicating with said external game console.

11. The game controller, as recited in claim 8, wherein said display screen is a LCD touch screen for directly communicating with said external game console.

12. The game controller, as recited in claim 1, wherein said display screen is a window frame having a display window for displaying a related information of said video game, wherein a sheet of said information is slid into said window frame within said display window for user to read said sheet at said controller body while playing said video game.

13. The game controller, as recited in claim 1, wherein said controlling portion further has a first controlling set and a second controlling set, wherein said display screen is located between said first and second controlling sets at a position adjacent to said holding portion.

14. The game controller, as recited in claim 12, wherein said controlling portion further has a first controlling set and a second controlling set, wherein said display screen is located between said first and second controlling sets at a position adjacent to said holding portion.

15. The game controller, as recited in claim 13, wherein said controlling portion further has a first controlling set and a second controlling set, wherein said display screen is located between said first and second controlling sets at a position adjacent to said holding portion.

16. The game controller, as recited in claim 1, wherein said holding portion further has two handle parts for being held by two hands of said gamer respectively, wherein said display screen is located between said two handle parts therebetween.

17. The game controller, as recited in claim 12, wherein said holding portion further has two handle parts for being held by two hands of said gamer respectively, wherein said display screen is located between said two handle parts therebetween.

18. The game controller, as recited in claim 13, wherein said holding portion further has two handle parts for being held by two hands of said gamer respectively, wherein said display screen is located between said two handle parts therebetween.

19. The game controller, as recited in claim 17, wherein said display screen is detachably coupling at a peripheral edge of said controller body at a position between said two handle parts.

20. The game controller, as recited in claim 18, wherein said display screen is detachably coupling at a peripheral edge of said controller body at a position between said two handle parts.
